(19) United States
(12) Patent Application Publication
(10) Pub. No.: US 2018/0173601 A1
(43) Pub. Date: Jun. 21, 2018

(54) ENERGY CONSUMPTION ANALYSIS BASED ON TELEMETRY DATA

(71) Applicant: Microsoft Technology Licensing, LLC, Redmond, WA (US)

(72) Inventors: Jihad Tafas, Redmond, WA (US); Sandeep Prabhakar, Bellevue, WA (US); lulian D. Calinov, Sammamish, WA (US); Eric Kratzer, Carnation, WA (US)

(21) Appl. No.: 15/382,296

(22) Filed: Dec. 16, 2016

(51) Int. Cl. G06F 11/30; G06F 17/30; G06F 1/32

(52) U.S. Cl. CPC G06F 11/3006; G06F 17/30598; G06F 2201/81; G06F 1/32; G06F 11/3062

(57) ABSTRACT

Analyzing energy consumption of one or more computer systems based on gathered telemetry data. Telemetry data is accessed from computer systems. The telemetry data includes parameters, each associated with a data type. The telemetry data is organized into data sets that each include at least one of the parameters. Each data set is associated with one computer system, and includes an energy consumption parameter indicative of an amount of energy used. The data sets are organized into data set clusters based on the at least one parameter included in each data set. For each cluster, each data set that satisfies an energy consumption threshold associated with further analyzing the data set to determine a cause of the energy amount used may be identified. The identified data sets are analyzed to find patterns associated with the at least one parameter that are likely cause of the amount of energy used.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data.

As such, the performance of many computing tasks has become distributed across a number of different computer systems and/or a number of different computing environments. For instance, there has been an increasing transition, with respect to both hardware and software, from on-premises to cloud based solutions. Computer systems within such complex distributed environments can therefore be difficult to monitor and analyze.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to analyzing energy consumption of one or more computer systems based on gathered telemetry data. For example, embodiments may include accessing telemetry data from one or more computer systems. The telemetry data may include one or more parameters that are each associated with a particular type of data. The accessed telemetry data may be organized into one or more data sets that each include at least one of the one or more parameters. Each data set is associated with one computer system of the one or more computer systems, and includes an energy consumption parameter that is indicative of an amount of energy used by each of the one or more computer systems.

The one or more data sets may be organized into one or more clusters of data sets based on the at least one parameter included in each of the one or more data sets. For each cluster of data sets, each data set that satisfies an energy consumption threshold that is indicative of whether the data set should be analyzed further to determine a cause of the amount of energy used by the corresponding computer system may be identified. The identified data sets may be analyzed to find one or more patterns associated with the at least one parameter included within each data set that are likely to be the cause of the amount of energy used.

Accordingly, telemetry data may be gathered from a large number of computer systems, organized into data sets, and further organized into clusters of data sets that have common parameters such that the data may be efficiently analyzed to determine root causes of any found energy consumption issues. Additionally, the root causes may be used to determine possible actions that a user may take in order ameliorate any energy consumption issues.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment for analyzing energy consumption of one or more computer systems based on gathered telemetry data.

FIG. 3 illustrates a table of telemetry data sets.

FIGS. 4A and 4B illustrates a table of telemetry data sets organized in a cluster of data sets.

FIG. 5 illustrates a flow chart of an example method for analyzing energy consumption of one or more computer systems based on gathered telemetry data.

### DETAILED DESCRIPTION

At least some embodiments described herein relate to analyzing energy consumption of one or more computer systems based on gathered telemetry data. For example, embodiments may include accessing telemetry data from one or more computer systems. The telemetry data may include one or more parameters that are each associated with a particular type of data. The accessed telemetry data may be organized into one or more data sets that each include at least one of the one or more parameters. Each data set is associated with one computer system of the one or more computer systems, and includes an energy consumption parameter that is indicative of an amount of energy used by each of the one or more computer systems.

The one or more data sets may be organized into one or more clusters of data sets based on at least one parameter included in each of the one or more data sets. For each cluster of data sets, each data set that satisfies an energy consumption threshold that is indicative of whether the data set should be analyzed further to determine a cause of the amount of energy used by the corresponding computer system may be identified. The identified data sets may be analyzed to find one or more patterns associated with the at least one parameter included within each data set that are likely to be the cause of the amount of energy used.

Accordingly, telemetry data may be gathered from a large number of computer systems, organized into data sets, and further organized into clusters of data sets that have common parameters such that the data may be efficiently analyzed to determine root causes of any found energy consumption issues. Additionally, the root causes may be used to determine possible actions that a user may take in order ameliorate any energy consumption issues.

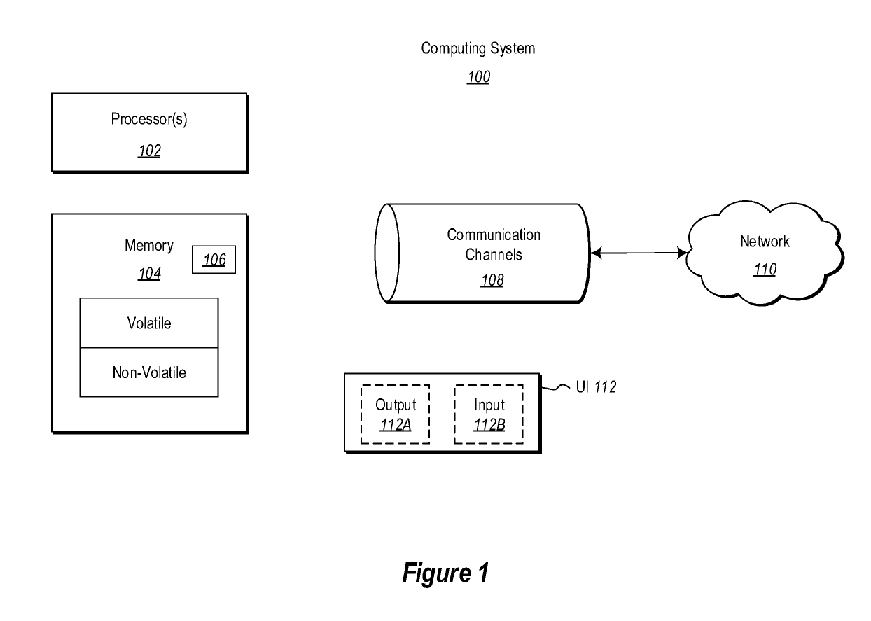

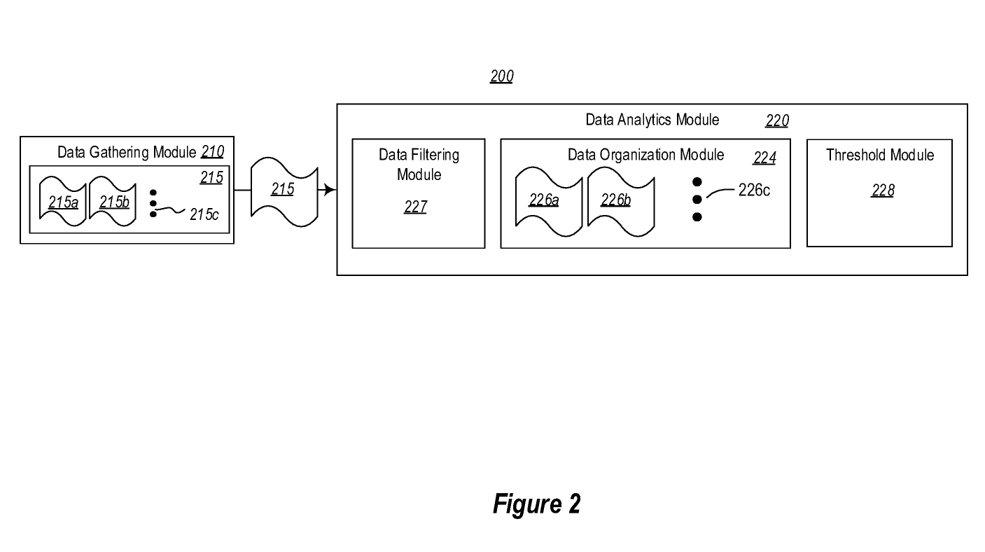

Some introductory discussion of a computing system will be described with respect to FIG. 1. Then analyzing energy consumption of one or more computer systems based on gathered telemetry data will be described with respect to FIGS. 2 through 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates an embodiment of a computer system 200 that may correspond to the computer system 100, as described with respect to FIG. 1. The computer system 200 includes various modules and/or functional blocks that may be used to analyze gathered telemetry data, as further described herein. The various modules and/or functional blocks of computer system 200 may be implemented on a local computer system or may be implemented on a distributed computer system that includes elements resident in the cloud or that implement aspects of cloud computing. The various modules and/or functional blocks of the computer system 200 may be implemented as software, hardware, or a combination of software and hardware. Notably, the computer system 200 may include more or less than the modules illustrated in FIG. 2. Additionally, some of the modules may be combined as circumstances warrant. Although not illustrated, the various modules of the computer system 200 may access and/or utilize a processor and memory, such as processor 102 and memory 104, as needed to perform their various functions.

As illustrated in FIG. 2, the computer system 200 includes a data gathering module 210. The data gathering module 210 may receive and/or access data 215 from one or more sources that are typically external to the computer system 200. In an example, the data gathering module 210 may access and/or receive the data 215 from a database that is designed to store the data 215. In another example, the data gathering module 210 may access and/or receive data from one or more individual computer systems that are external to computer system 200.

The data 215 may be any type of data. For instance, the data 215 may be telemetry data that is collected from a large number of external computer systems or devices for further analysis related to energy consumption of the external computer systems from which the telemetry data was gathered. Accordingly, the data 215 may herein after also be referred to as telemetry data. As such, the telemetry data 215 may be any reasonable type of telemetry data that is collected for purposes related to determining both causes and solutions of either poor or very good energy consumption of the computer systems from which the telemetry data is gathered.

Notably, the data gathering module may also identify parameters that correspond to the gathered telemetry data 215, as illustrated by parameter 215a and parameter 215b. While only two parameters are shown in FIG. 2, ellipses 215c illustrates that any number of additional parameters may be identified by the data gathering module. The parameters 215a, 215b, and 215c (hereinafter also referred to as “parameters 215”) describe information related to the data 215 that may be used to categorize and organize the data 215, as described more fully herein.

For example, the parameters may include specific information about the data (and ultimately the computer system from which the data originated) such as a device ID, energy consumption, central processing unit (CPU) usage, geographical information, application version information, particular running applications, error codes, operating system version information, firmware version, device type, processor type, events or instances of a specific operation, and so forth. Additionally, the parameters may include other computer system states such as a level of screen brightness, whether Wi-Fi™ is enabled, whether BLUETOOTH® is enabled, whether a display is on or in a standby state, whether a battery saver mode is being employed, whether a user is present at the computer system, whether an external device (e.g., external hard drive, speakers, microphone, and so forth) is connected to the computer system, a current power source of the computer system (e.g., battery), a power mode of the computer system, a date and time associated with when the other parameters occurred (i.e., time stamp), and so forth.

While particular parameters are described herein, any number of different types of parameters may be utilized. As such, the embodiments disclosed herein are not limited by the types of parameters that are identified as being associated with the telemetry data 215. Accordingly, the embodiments and the claims disclosed herein are not limited by the type of the telemetry data 215 and corresponding parameters 215a, 215b, and 215c.

In addition to including the parameters 215 that describe information related to the telemetry data 215, the telemetry data 215 may also include Personal Identifiable Information (PII) data that has been collected in the data. Oftentimes, the PII data has been collected due to an error in the instructions that govern how the data is collected. In other instances, the PII data may be collected due to user misuse of one or more features of a program or the like. For example, a user may input PII data in a place that is not meant for the collection of PII data. This may inadvertently lead to the accidental collection of the PII data. Accordingly, the embodiments disclosed herein include a data filtering module 222, as further discussed herein, which allows for filtering such unwanted data (e.g., PII data).

As illustrated, the computer system 200 of FIG. 2 may also include a data analytics module 220 that is configured to analyze the telemetry data 215 in terms of the effect on energy consumption of the computer system(s) from which the telemetry data was gathered. As shown, the data analytics module may include a data organization module 224. The data organization module 224 may organize and/or group the telemetry data 215 into one or more data sets that each comprise data associated with a particular computer system from which the data was gathered, as illustrated by data set 226a and data set 226b. While only two data sets are shown, ellipses 226c illustrate that any number of additional data sets may be organized. Accordingly, the data sets 226a, 226b, and 226c are hereinafter also referred to as data sets 226.

As illustrated, the processing module 220 may include a filtering module 222 that is configured to perform filtering based on the parameters 215 to determine those parameters that are always (or almost always) unique to a particular data set 226 of the telemetry data 215. For example, in one embodiment, the filtering module 222 may keep only parameters contained in a large number of data sets while filtering away parameters only belonging to one or a very small number of the data sets. For instance, the data sets 226 may filter PII data, as such data is both unwanted and unique to each individual data set. Additionally, in some embodiments, the telemetry data 215 may include multiple instances of a data set 226 that is collected from the same computer device, although perhaps at a different time. Since there may be no need to analyze the multiple instances, the filtering module 222 may also be configured to remove the multiple instances of a data set. The filtering module 222 may also provide data cleansing and other related procedures.

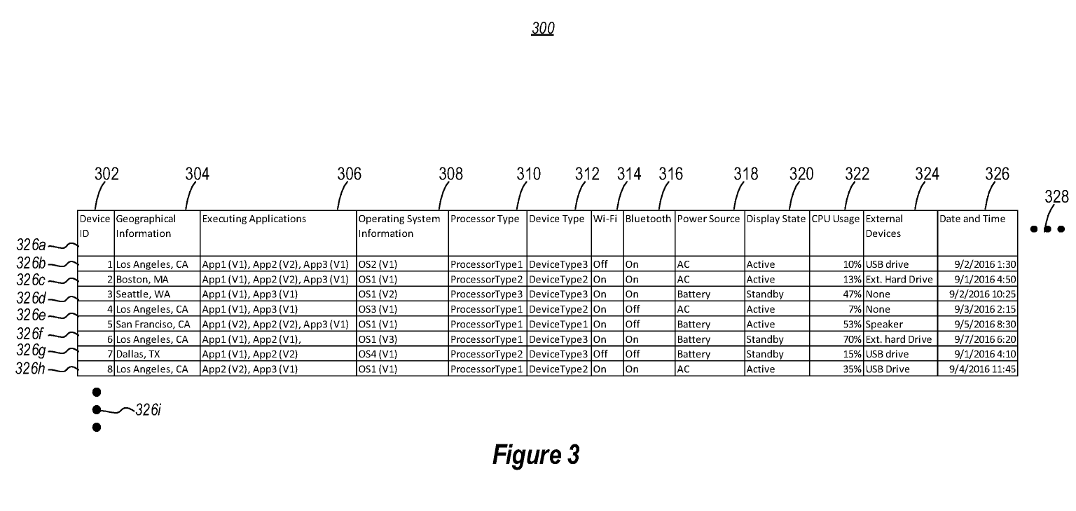

FIG. 3 illustrates a specific example of the telemetry data 215 that has been gathered by the data gathering module 210 and organized into numerous data sets by the data organization module 224. Notably, while not explicitly shown, one or more parameters associated with the data sets of FIG. 3 may also have been filtered prior to organizing the final data sets illustrated. As shown in FIG. 3, the telemetry data is organized into a table 300 having eight data sets 326a through 326h (referred to collectively herein as data sets 326) that each may correspond to specific instances of the telemetry data 215, as discussed herein. While eight data sets 326 are included in FIG. 3, ellipses 326i represents that there may be any number of data sets that are analyzed by the data organization module 224 (i.e., there may be more or less data sets than the eight data sets illustrated in FIG. 3). Typically, however, the table 300 may include a large number of telemetry data sets, usually hundreds of millions or more.

As shown, FIG. 3 includes 13 parameters (i.e., parameters 302 through 326) within table 300 that relate to the eight data sets 326. Each of the parameters 302 through 326 may correspond to the parameters 215, as described with respect to FIG. 2. While 13 parameters are included within table 300, ellipses 328 represents that any number of additional parameters may also be included within telemetry data 215, data sets 326, and table 300. Notably, the telemetry data organized as the table 300 is a simplified version of telemetry data for ease of illustration only. Accordingly, the data organization module 224 may organize the telemetry data in any other reasonable way, and as such, the actual structure of the table 300 should not be used to limit the embodiments disclosed herein.

As further shown in FIG. 3, each of the telemetry data sets 326 are associated with a device ID 302 that may be assigned by the computer system 200. The device ID 302 may be used to identify from which computer system or device any given telemetry data 215 was collected. For example, such computer systems may comprise a desktop computer, a laptop computer, a smart phone, a tablet, a smart watch, or any other type of computer device. As illustrated, the telemetry data set 326a is assigned device ID 1, while the data set 326b is assigned the device ID 2, to show that telemetry data was collected from different computer systems. Similarly, the remaining telemetry data sets are also assigned a specific device ID when they are collected from different computer devices, as illustrated in FIG. 3.

Notably, the parameter 324 corresponds to a time stamp that specifies the date and time that each instance of the telemetry data was collected. In some embodiments, only telemetry data 215 that is collected within a given time period may be analyzed by the data analytics module 220 in order to help ensure that the data sets are useful in comparison to one another. In other embodiments, however, data collection may not be limited to a specific time period, and in such embodiments the table 300 may not include the time stamp parameter 324.

Once the telemetry data 215 has been organized into data sets as shown and described with respect to FIG. 3, the data sets may be further organized into clusters of data sets by the data organization module. Accordingly, the data organization module 224 may organize the data sets 226 into clusters of data sets by grouping data sets based on any number of factors. In an example, the data organization module may organize clusters of data sets based on identifying matching combinations of parameters identified within each data set of such a cluster.

In a more specific example, the data organization module may organize clusters of data sets based on a device type, operating system version, and or processor type. In another example, the data organization module may first identify which data sets have either poor or very good energy consumption and organize those data sets into a poor energy consumption cluster and a very good energy consumption cluster. Patterns associated with causes of the poor or very good energy consumption may then be determined by the data analytics module, as further described herein. Regardless of the factors used to cluster data sets, such clusters may be useful in analyzing the data sets for likely causes of either poor or very good energy consumption, as further described herein.

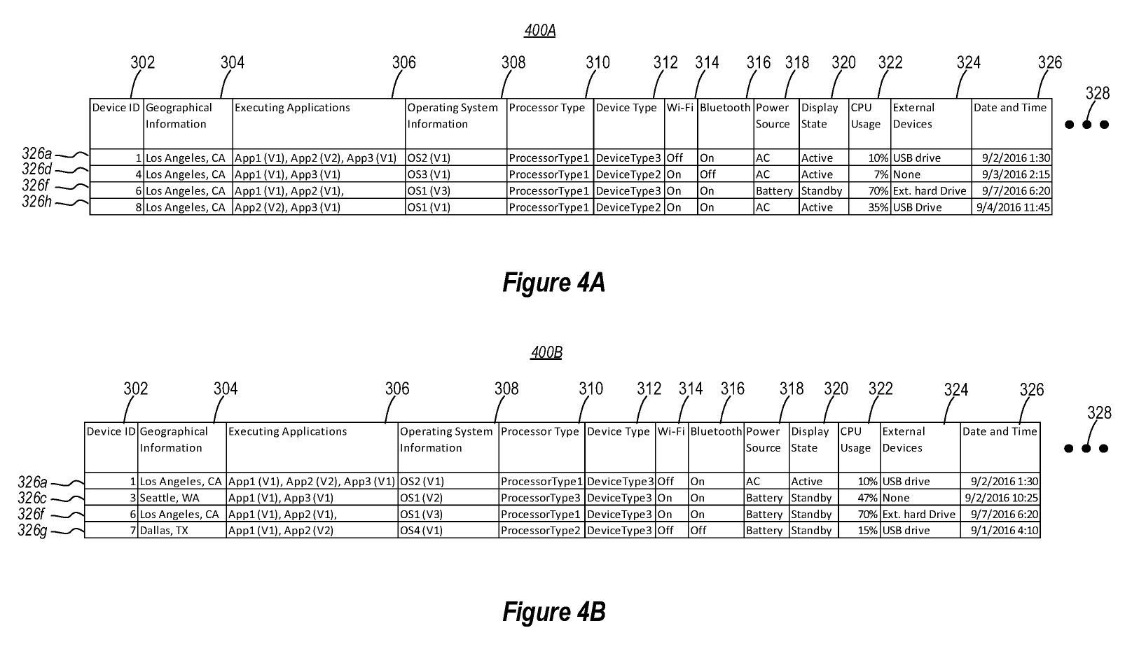

In more specific examples, FIGS. 4A and 4B illustrate how the data sets 326 of FIG. 3 may be further organized according to parameters that are the same or similar amongst organized data sets. As shown, FIG. 4A illustrates a subset of the data sets 326 (as illustrated in FIG. 3) that are organized in a cluster of data sets at least partially according to the geographic location of the computer systems from which the telemetry data was gathered. More specifically, geographical information parameter 304 shows that data set 326a, data set 326d, data set 326f, and 326h were all gathered from computer systems located in Los Angeles, Calif. Additionally, as shown by processor type parameter 310, each of the given data sets of FIG. 4A correspond to computer systems having the same type of processor. As such, the type of processor may also have been considered when organizing the cluster of data sets of FIG. 4.

FIG. 4b illustrates another subset of the data sets 326 that are organized into a cluster of data sets at least partially according to the device type of the computer systems from which the telemetry data was gathered. More specifically, device type parameter 312 shows that data set 326a, data set 326c, data set 326f, and data set 326g all correspond to computer systems that are of the same device type (i.e., DeviceType3). For example, the device type parameter may relate to a type of laptop computer, desktop computer, smart phone, tablet, or smart watch. While device type is the most obvious parameter to consider in creating the cluster of FIG. 4B, any of the other parameters may also be considered when organizing such a cluster.

Accordingly, although not illustrated, additional parameters may also be used to further define and/or organize the data sets into clusters, as appropriate. For example, only those data sets collected that correspond to computer systems having the same operating system, processor type, and device type may be organized into a cluster of data sets, which data sets may be further analyzed by data analytics module 220. In some embodiments, data sets may only be organized into clusters (e.g., as shown in FIGS. 4a and 4b) when all of the parameters of the data sets within the cluster are the same.

In other embodiments, data sets may be organized into clusters when only one or more parameters are the same amongst data sets of a cluster. In yet other embodiments, data sets may be organized into clusters of data sets when a certain threshold of parameters of separate data sets are the same. For example, only when at least 90% of parameters of separate data sets are the same will those data sets be organized into a group of data sets to be analyzed by the data analytics module. Similarly, any other applicable threshold may be used (e.g., 10%, 20%, 30%, 40%, 50%, and so forth).

Returning to FIG. 2, the data analytics module also includes threshold module 228 that is configured to determine whether particular data sets, generally within an organized cluster of data sets, meet an energy consumption threshold (and potentially a frequency threshold, as further described herein). Accordingly, once the data/parameters have been organized into data sets 226 and/or clusters of data sets, as shown in FIGS. 4A and 4B, the threshold module 228 may perform further analytics to determine whether any data sets show energy consumption that meets a certain threshold. As such, at least one of the parameters included within any given data set may relate to energy consumption (e.g., CPU usage, memory usage, GPU usage, and so forth). For example, the CPU usage parameter 322 (of FIGS. 3, 4A, and 4B) may be used to determine whether any of the data sets 326 meet such an energy consumption threshold.

In some embodiments, the energy consumption threshold may only relate to poor energy consumption. For instance, only data sets having parameters that show poor enough energy consumption (i.e., in relation to the computer system(s) from which the data set(s) were gathered) to meet the energy consumption threshold may be further analyzed by the threshold module to determine possible causes of the poor energy consumption, as further described herein. In an example using the CPU usage parameter 322 of FIG. 4A, the energy consumption threshold may comprise a CPU usage of at least 50%. As such, only data set 326f would meet the threshold relating to poor energy consumption, and thus be identified as a data set to further analyze for possible causes.

Alternatively, the energy threshold may only relate to very good energy consumption. For instance, only data sets having parameters that show good enough energy consumption (i.e., in relation to the computer system(s) from which the given data set(s) were gathered) to meet the energy consumption threshold may be further analyzed by the threshold module to determine possible causes of the very good energy consumption. In an example using the CPU usage parameter 322 of FIG. 4A, the energy consumption threshold may comprise a CPU usage of less than 10%. As such, only data set 326d would meet the threshold relating to very good energy consumption, and thus be identified as a data set to further analyze for possible causes.

In other embodiments, the threshold module may utilize both a threshold for poor energy usage and a threshold for very good energy usage. Accordingly, in such embodiments, the threshold module may further analyze all data sets that meet either requirement in order to determine possible causes of the poor energy consumption and/or possible causes of the very good energy consumption. While particular thresholds (e.g., CPU usage of at least 50%, CPU usage of less than 10%) have been discussed herein, the principles described herein are not limited to any particular thresholds. As such, any appropriate thresholds may be determined and/or modified, as applicable.

Once data sets that meet either the poor energy consumption threshold or the very good energy consumption threshold have been identified, a threshold relating to the frequency of such data sets (i.e., those data sets meeting one of the two thresholds) may also be used in order to determine whether further analysis regarding likely causes of the poor or very good energy consumption will be performed. In some embodiments, the threshold may comprise a percentage of the data sets within a particular cluster of data sets that meet the energy consumption threshold. For example, unless at least 30% of data sets within a particular cluster meet the energy consumption threshold, the data sets that do meet the energy consumption threshold will not be further analyzed for likely root cause(s) of the energy consumption corresponding to those data sets.

In other embodiments, the threshold may comprise a total number of data sets within a cluster that meet the energy consumption threshold. For example, unless at least 1,000 data sets within a particular cluster meet the energy consumption threshold, the data sets that do meet the energy consumption threshold will not be further analyzed for likely root cause(s) of the energy consumption corresponding to those data sets. In other examples, the frequency threshold may be 100, 10,000, or 100,000. Again, while particular frequency thresholds (e.g., at least 30% of data sets within a particular cluster meet the energy consumption threshold, at least 1,000 data sets within a particular cluster meet the energy consumption threshold) have been discussed herein, the principles described herein are not limited to any particular frequency thresholds. As such, any appropriate frequency thresholds may be determined and/or modified, as applicable.

Accordingly, in some embodiments, when the frequency threshold is not met, the data sets that meet the energy consumption threshold may be discarded in relation to further analysis regarding possible root causes, as such data sets may simply be considered anomalies. Alternatively, in some embodiments, even when the frequency threshold is not met, the data sets that meet the energy consumption threshold may still be further analyzed regarding possible root causes.

Once the energy consumption threshold and the frequency threshold have been satisfied (and in some cases just the energy consumption threshold), the data analytics module may further analyze and determine likely root causes of the energy consumption of the given data sets. For instance, the data analytics module may determine that a particular version of an executing software application, a particular combination of software applications executing at the same time, a particular geographic location, a particular device in a particular state (e.g., battery saver state), and so forth may be likely causes of poor or very good energy consumption.

In some embodiments, the data analytics module may identify patterns amongst data sets of a given cluster that have met the energy consumption threshold. Such patterns may indicate, or at least enable the data analytics module to predict, the likely root cause(s) of such energy consumption. For instance, the data analytics module may identify a pattern of data sets comprising a particular device type that is showing poor energy consumption while executing a particular application (or combination of applications). In such an example, the data analytics module may then determine patterns as to what operating system versions and/or processor types associated with the identified device type are most prevalent in showing signs of poor energy consumption. The data analytics module may then determine that the software application is causing energy consumption issues only with respect to the particular device type having a particular operating system version or processor type. As such, the data analytics module may determine that the software application needs to be modified in order to properly execute with respect to the particular device type having those configurations.

In another example, the data analytics module may determine a pattern comprising poor energy consumption in a particular geographic location. In such a case, it may further be determined that a particular energy company, or infrastructure, that provides energy to that geographical location is currently experiencing problems. Accordingly, the data analytics module may be configured to determine what is causing poor or very high energy consumption based on analyses of patterns, or what is common, among data sets showing poor or very high energy consumption. While particular types of root causes are discussed herein, any applicable root cause may come within the principles described herein. Accordingly, the discussed root causes are not meant to limit the disclosure of possible root causes, as essentially unlimited numbers of root cause may be determined using the principles described herein.

Once likely causes have been determined by the data analytics module, those cause may then be output to a user of a computer system having energy consumption issues. Additionally, one or more possible user actions may also be outputted to a user such that the user may take the one or more possible user actions to improve energy consumption. For example, such outputs may include a notification that software is to be upgraded, an operating system is to be upgraded, a process is to be killed, a software application is to be killed, hardware is to be upgraded, and so forth.

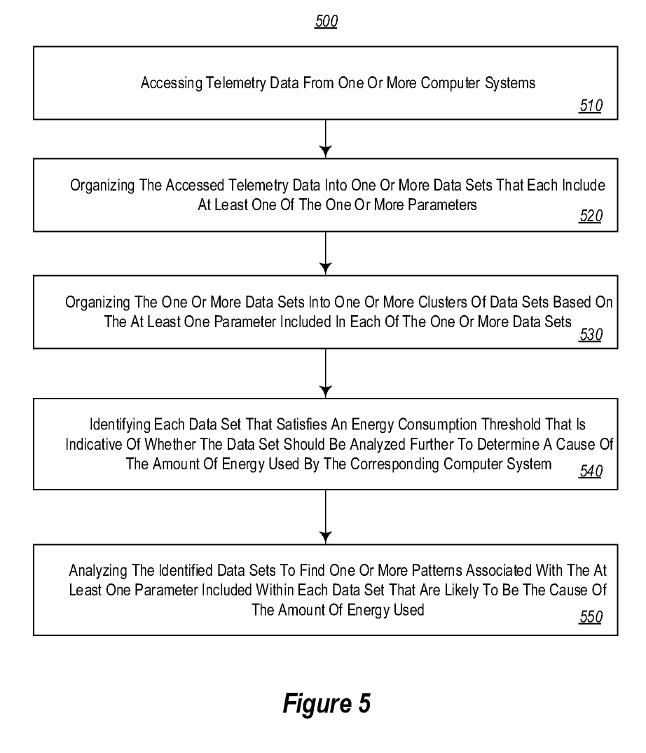

FIG. 5 illustrates a flowchart of a method 500 for analyzing energy consumption of one or more computer systems based on gathered telemetry data. Description of the method 500 includes frequent reference to FIGS. 2 through 4B. The method begins by accessing telemetry data from one or more computer systems (Act 510). For example, any data relating to energy consumption may be gathered (or received) from a large number of computer systems external to the computer system 200. Such telemetry data may include one or more parameters that are each associated with a particular type of data. For instance, parameters may include parameters 302-324, as illustrated in FIG. 3.

The method also includes organizing the accessed telemetry data into one or more data sets that each include at least one of the one or more parameters (Act 520). For example, gathered telemetry data may first be organized into data sets such as data sets 326 of FIG. 3. Each data set may further be associated with one computer system of the one or more computer systems, and include an energy consumption parameter that is indicative of an amount of energy used by each of the one or more computer systems. For example, with respect to FIG. 3, each data set 326 is associated with a device ID parameter 302, as well as an energy consumption parameter in the form of CPU usage parameter 322.

The method 500 also includes organizing the one or more data sets into one or more clusters of data sets based on at least one parameter included in each of the one or more data sets (Act 530). For example, the data sets of FIG. 3 have been organized into two separate clusters 400A and 400B, as illustrated in FIGS. 4A and 4B, respectively. More specifically, the cluster 400A may be organized based on at least the geographical information parameter 304 or the processor type parameter 310. The cluster 400B, on the other hand, may be organized at least partially based on the device type parameter 312.

The method 500 further includes, for each cluster of data sets, identifying each data set that satisfies an energy consumption threshold that is indicative of whether the data set should be analyzed further to determine a cause of the amount of energy used by the corresponding computer system (Act 540). For example, each data set within cluster 400A and 400B that meets an energy consumption threshold may be identified. In a more specific example, there may be two energy consumption thresholds, including a poor energy consumption threshold and a very good energy consumption threshold. The poor energy consumption threshold may comprise a CPU usage of more than 40%, while the very good energy consumption threshold may comprise a CPU usage of less than 10%. As such, data set 326f may meet the poor energy consumption threshold, while data set 326d may meet the very good energy consumption threshold.

In some embodiments, a frequency threshold may also be used to determine whether further analysis regarding the root causes of energy consumption of given data set(s) is to be performed. The method also includes analyzing the identified data sets to find one or more patterns associated with the at least one parameter included within each data set that are likely to be the cause of the amount of energy used (Act 550).

For instance, with respect to FIG. 4B, the data analytics module may analyze cluster 400B to find that the poor energy consumption of data sets 326c and 326f is associated with a pattern of executing “Appl (V1)” while using “OS1”. Accordingly, the data analytics module may determine that executing that particular software application on that particular operating system is causing poor energy consumption. Such findings may then be outputted to the user along with one or more actions the user may take to ameliorate the problem. For instance, the user may be prompted to update the software application or operating system.

In this way, telemetry data may be gathered from a large number of computer systems, organized into data sets, and further organized into clusters of data sets that have common parameters such that the data may be efficiently analyzed to determine root causes of any found energy consumption issues. Additionally, the root causes may be used to determine possible actions that a user may take in order ameliorate any energy consumption issues.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable storage media having stored thereon computer-executable instructions that are executable by the one or more processors to cause the computer system to analyze energy consumption of one or more computer systems based on gathered telemetry data, the computer-executable instructions including instructions that are executable to cause the computer system to perform at least the following:
access telemetry data from one or more computer systems, the telemetry data including one or more parameters, each of the one or more parameters being associated with a particular type of data;
organize the accessed telemetry data into one or more data sets that each include at least one of the one or more parameters, each data set being associated with one computer system of the one or more computer systems, and including an energy consumption parameter that is indicative of an amount of energy used by each of the one or more computer systems;
organize the one or more data sets into one or more clusters of data sets based on at least one parameter included in each of the one or more data sets;
for each cluster of data sets, identify each data set that satisfies an energy consumption threshold that is indicative of whether the data set should be analyzed further to determine a cause of the amount of energy used by the corresponding computer system; and
analyze the identified data sets to find one or more patterns associated with the at least one parameter included within each data set that are likely to be the cause of the amount of energy used.

2. The computer system in accordance with claim 1, wherein the computer-executable instructions include instructions that are executable to cause the computer system to determine whether a frequency threshold is satisfied before analyzing the identified data sets.

3. The computer system in accordance with claim 2, wherein the frequency threshold comprises a threshold associated with the frequency of identified data sets that satisfy an energy consumption threshold.

4. The computer system in accordance with claim 1, wherein the computer-executable instructions include instructions that are executable to cause the computer system to output one or more suggested actions to a user that are likely to improve the amount of energy used.

5. The computer system in accordance with claim 1, wherein the one or more parameters include at least one of a device type, a processor type, an operating system version, and a geographic location.

6. The computer system in accordance with claim 1, wherein organizing the one or more data sets into one or more clusters comprises identifying at least one similar parameter in each data set of a cluster.

7. The computer system in accordance with claim 1, wherein organizing the one or more data sets into one or more clusters comprises organizing the data sets based on a device type parameter that indicates a device type of each computer system from which telemetry data was accessed.

8. A method, implemented at a computer system that includes one or more processors, for analyzing energy consumption of one or more computer systems based on gathered telemetry data, comprising:
accessing telemetry data from one or more computer systems, the telemetry data including one or more parameters, each of the one or more parameters being associated with a particular type of data;
organizing the accessed telemetry data into one or more data sets that each include at least one of the one or more parameters, each data set being associated with one computer system of the one or more computer systems, and including an energy consumption parameter that is indicative of an amount of energy used by each of the one or more computer systems;
organizing the one or more data sets into one or more clusters of data sets based on at least one parameter included in each of the one or more data sets;
for each cluster of data sets, identifying each data set that satisfies an energy consumption threshold that is indicative of whether the data set should be analyzed further to determine a cause of the amount of energy used by the corresponding computer system; and
analyzing the identified data sets to find one or more patterns associated with the at least one parameter included within each data set that are likely to be the cause of the amount of energy used.

9. The method in accordance with claim 8, further comprising determining whether a frequency threshold is satisfied before analyzing the identified data sets.

10. The method in accordance with claim 9, wherein the frequency threshold comprises a threshold associated with the frequency of identified data sets that satisfy an energy consumption threshold.

11. The method in accordance with claim 8, further comprising outputting one or more suggested actions to a user that are likely to improve the amount of energy used.

12. The method in accordance with claim 8, wherein the one or more parameters include at least one of a device type, a processor type, and an operating system version.

13. The method in accordance with claim 8, wherein organizing the one or more data sets into one or more clusters comprises identifying at least one similar parameter in each data set of a cluster.

14. The method in accordance with claim 8, wherein organizing the one or more data sets into one or more clusters comprises organizing the data sets based on a device type parameter that indicates a device type of each computer system from which telemetry data was accessed.

15. A computer program product comprising one or more hardware storage devices having stored thereon computer-executable instructions that are executable by one or more processors of a computer system to analyze energy consumption of one or more computer systems based on gathered telemetry data, the computer-executable instructions including instructions that are executable to cause the computer system to perform at least the following:
access telemetry data from one or more computer systems, the telemetry data including one or more parameters, each of the one or more parameters being associated with a particular type of data;
organize the accessed telemetry data into one or more data sets that each include at least one of the one or more parameters, each data set being associated with one computer system of the one or more computer systems, and including an energy consumption parameter that is indicative of an amount of energy used by each of the one or more computer systems;
organize the one or more data sets into one or more clusters of data sets based on at least one parameter included in each of the one or more data sets;
for each cluster of data sets, identify each data set that satisfies an energy consumption threshold that is indicative of whether the data set should be analyzed further to determine a cause of the amount of energy used by the corresponding computer system; and
analyze the identified data sets to find one or more patterns associated with the at least one parameter included within each data set that are likely to be the cause of the amount of energy used.

16. The computer program product in accordance with claim 15, wherein the computer-executable instructions include instructions that are executable to cause the computer system to determine whether a frequency threshold is satisfied before analyzing the identified data sets.

17. The computer program product in accordance with claim 16, wherein the frequency threshold comprises a threshold associated with the frequency of identified data sets that satisfy an energy consumption threshold.

18. The computer program product in accordance with claim 15, wherein the computer-executable instructions include instructions that are executable to cause the computer system to output one or more suggest actions to a user that are likely to improve the amount of energy used.

19. The computer program product in accordance with claim 15, wherein organizing the one or more data sets into one or more clusters comprises identifying at least one similar parameter in each data set of a cluster.

20. The computer program product in accordance with claim 15, wherein organizing the one or more data sets into one or more clusters comprises organizing the data sets based on a device type parameter that indicates a device type of each computer system from which telemetry data was accessed.
